(19) United States
(12) Patent Application Publication
(10) Pub. No.: US 2010/0082463 A1
(43) Pub. Date: Apr. 1, 2010

(54) Method for Tracing Non-Payers

(75) Inventor: Eduard Van Den Bergh, Barendrecht (NL)

Correspondence Address: THE WEBB LAW FIRM, P.C., 700 KOPPERS BUILDING, 436 SEVENTH AVENUE, PITTSBURGH, PA, 15219, US

(73) Assignee: WHEEL LOCK B.V., Rotterdam (NL)

(21) Appl. No.: 12/519,014

(22) PCT Filed: Dec. 13, 2007
(86) PCT No.: PCT/NL2007/050650

§ 371 Date: Nov. 23, 2009

(30) Foreign Application Priority Data
Dec. 13, 2006 (NL) 2000372

(51) Int. Cl. G06Q 50/00; G06Q 10/00; G06Q 40/00; G06F 15/16

(52) U.S. Cl. 705/30; 709/219

(57) ABSTRACT

The invention relates to a method for digital tracing of non-payers. The method comprises at least the steps, performed under the control of a platform server via a digital network, of a monitoring party scanning number plates of vehicles with a suitable input device; requesting information from a database of number plates and non-payers; sending the status data relating to the debt position of the vehicle owner to the input device, and immobilizing the vehicle as the case arises. The invention also relates to a computer program comprising program instructions for a computer to execute the method, and a computer adapted to execute such a computer program.

The invention relates to a method for tracing non-payers and for the seizure of property, in particular vehicles. The invention also relates to a computer program comprising program instructions for a computer to execute the method. The invention further relates to a computer adapted to execute such a computer program.

Persons who accumulate debts and subsequently do not pay these debts (in full) represent an increasing social problem. While non-payment of debts can be very irritating for creditors, it is also very detrimental to society as a whole, since creditworthiness is compromised, insurance premiums rise, checking costs increase and so on. Not only has it been found difficult to trace non-payers, it has also been found that, once a non-payer has been traced, it is often very difficult to induce him/her to pay his/her debts. There is therefore a need for a system which provides a solution to, among others, the above stated problems.

The invention has for its object to provide a method with which non-payers can be traced in simple manner and with which at least part of the debt can be settled.

This objective is achieved according to the invention by a method which is characterized in a first variant in that it comprises at least the following steps, performed under the control of a platform server via a digital network, of:
A) a monitoring party scanning number plates of vehicles with a suitable input device;
B) making contact by means of the input device with a number plates database;
C) retrieving the identity data of the person associated with the vehicle having the relevant number plate from the number plates database;
D) the number plates database sending the identity data to the platform server;
E) making contact with a non-payers database by means of the platform server;
F) retrieving the status data of the relevant person from the non-payers database;
G) the non-payers database sending the status data to the platform server;
H) the platform server sending the status data to the input device.

On the basis of scanning number plates the invented method allows almost instant insight into the debt position of the person in whose name the vehicle in question is registered. This is achieved by realizing a coupling of at least two databases via a platform server, wherein the databases comprise at least a number plates database and a non-payers database. The identity of the owner of the number plate can be determined by making contact with the number plates database via the platform server using the input device. On the basis of this identity the status data of the relevant person are then retrieved from the non-payers database. According to the invention this takes place by making contact with a non-payers database by means of the platform server, and retrieving the status data from this database. In the context of the present application status data are understood to mean all data which provide an insight into the debt position of the person in question.

Using the invented method a large number of non-payers can be traced in simple manner and within a short period of time. A further advantage of the method according to the invention is that a component of the property of a possible non-payer is immediately available for seizure, i.e. the registered vehicle. Although it is common practice in the existing method to seize a part of the property of the non-payer, there is generally sufficient time available to conceal or protect particular property components from seizure.

In a second embodiment variant the method for digitally tracing non-payers and seizing property, in particular vehicles, is characterized in that it comprises at least the following steps, performed under the control of a platform server via a digital network, of:
A) a monitoring party scanning number plates of vehicles with a suitable input device;
B) providing a combined database comprising at least number plate data, identity data and status data relating to the debt position of the person associated with number plates;
C) making contact with the combined database via the platform server by means of the input device;
D) retrieving the identity data of the person associated with the vehicle having the relevant number plate from the combined database;
E) retrieving the status data of the relevant person from the combined database;
F) the combined database sending the status data to the platform server;
G) the platform server sending the status data to the input device.

The second variant has the advantage that the platform server need only make contact with one combined database.

A further preferred variant of the method according to the invention also comprises the step of immobilizing the vehicle of the person in question if the status data indicate that the person is a non-payer. Immobilizing of property of a non-payer can take place in any known manner. Immobilizing of the vehicle is preferably performed by arranging at least one wheel clamp. It is important here that the immobilizing operations can be performed rapidly, for instance when a large number of wheel clamps have to be arranged, or when the driver of the relevant vehicle is in the vicinity and attempts to prevent placing of the wheel clamp. A particularly suitable wheel clamp is described in Netherlands application number 2000372, the publication of which is incorporated in its entirety in the present application.

In yet another preferred variant the method according to the invention is characterized in that immobilizing of the vehicle is performed only when the amount of the debt of the non-payer exceeds a determined limit, and/or it is permitted within the legal framework to render inoperative, seize and/or secure the vehicle. This prevents unnecessary discussion and cost.

According to the first variant of the invention, determined number plate data are sent to a central platform server by the monitoring party using an input device, for instance a suitable scanner for number plates. This central server substantially fully controls the implementation of the method. After receiving the number plate data, the platform server then makes contact in step B) with a number plates database. After step C) the identity data are sent in step D) to the input device via the platform server. These data are then forwarded in step E) to a non-payers database, again via the central platform server. If the status data received by the input device indicate that the person who owns the vehicle with the relevant number plate is a non-payer, according to a preferred embodiment of the invention the vehicle is then immobilized.

According to the second variant of the invention, a combined database is provided which comprises at least number plate data, identity data and status data relating to the debt position of the person associated with the number plates. Determined number plate data is sent to a central platform server by the monitoring party using an input device, for instance a suitable scanner for number plates. After receiving the number plate data, this platform server then makes contact in step C) with the combined database. After steps D) and E) the status data are sent in steps F) and G) to the input device via the platform server. If the status data received by the input device indicate that the person who owns the vehicle with the relevant number plate is a non-payer, according to a preferred embodiment of the invention the vehicle is then immobilized.

In the tracing system according to the invention the input device(s), the platform server, the databases of number plate holders and non-payers and, if desired, other computers, can in principle be connected to each other by any digital network. Particularly suitable however is the interne, wherein the mutually connected computers exchange information by making use of services such as email and the world wide web (www).

According to the invention a vehicle is immobilized only when the number plate holder is found to have a non-paid debt, and preferably only when a judgement has been given against the number plate holder in question, and/or (full) payment has not been made despite this judgment. It is possible to further characterize the method by creating the possibility of on-the-spot payment of the debt. The non-payer can perform a payment transaction to this effect. This payment transaction can in principle be performed in any way, for instance by means of prepaid card, telephone, SMS and/or credit card. In a particularly suitable embodiment of the method according to the invention, the method also comprises of the platform server checking performance of the payment. This can for instance be carried out by realizing a network connection between the platform server and the client computer of a payment institution. Once the payment has been received by the payment institution, this latter sends a message, if desired automatically, to the platform server. It is also possible to have the payment performed via the platform server. In this case the monitoring party can be informed of the payment immediately after it has been received.

The invention will now be further elucidated on the basis of the non-limitative exemplary embodiments described in the figures. Herein:

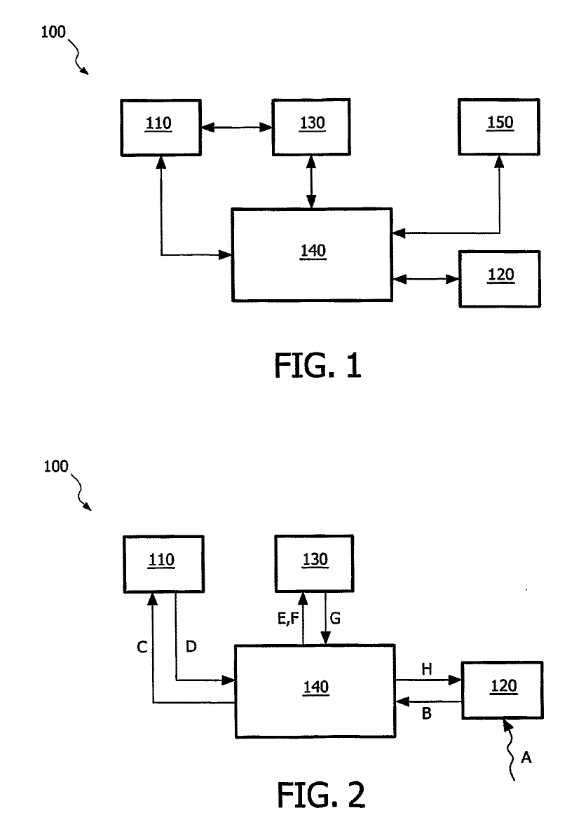

FIG. 1 shows a schematic representation of an electronic network according to a first embodiment of the invention;

FIG. 2 shows a schematic representation of the method steps according to the first embodiment of the invention;

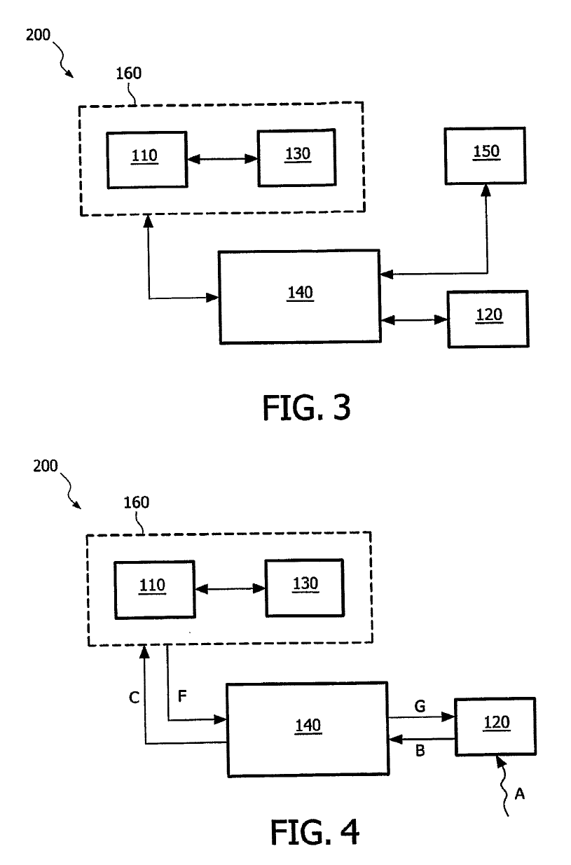

FIG. 3 shows a schematic representation of an electronic network according to a second embodiment of the invention; and

FIG. 4 shows a schematic representation of the method steps according to the second embodiment of the invention.

Referring to FIG. 1, a system 100 for digitally tracing non-payers comprises according to an embodiment of the invention a platform server 140 and at least an input/output device 120, such as for instance a scanner for number plates. System 100 further comprises at least two databases, a first database 110 comprising at least the identity data of number plate holders, and a second database 130 comprising at least the identity data of non-payers. Platform server 140 can be connected via an electronic network to databases 110, 130 and to input/output device 120. If desired, platform server 140 is also connected to server 150 of a payment institution. The electronic network can be a wireless network, a cable network, an analog network, a digital network, and/or a combination thereof. A monitoring party, such as for instance a bailiff, has at his/her disposal an input/output device 120 with which vehicle number plates can be registered. If desired, input/output device 120 can also be a personal computer (PC) connected to platform server 140 via the network connection. The payment service is provided by payment institutions, which are likewise able to communicate with platform server 140 via server 150. If desired, platform server 140 further comprises a computing unit, an input/output unit which can communicate with the computing unit and allows a user, for instance a monitoring party, to receive output from and/or provide input to the computing unit. A memory communicates with the computing unit and stores the necessary program code and data enabling execution of the desired functions of platform server 140. The memory particularly comprises the necessary software enabling execution of the method according to the present invention. Platform server 140 comprises and/or is in communication with at least two databases 110, 130 in which data relating to number plate holders and non-payers are stored, and which data can be accessed by platform server 140 and can be processed if desired. The databases can be searched in known manner by a suitable software component of the platform server.

Referring to FIG. 2, in a first variant of the method a number plate of a vehicle is scanned using a suitable input device 120 by a monitoring party. Input device 120 comprises for instance a vehicle provided with an ANPR (automatic number plate recognition) system. By means of input device 120 contact is made via platform server 140 (step B) with the number plates database 110. This takes place in step C). The identity data of the person associated with the vehicle with the relevant number plate is retrieved from the number plates database 110 and in step D) sent by the number plates database to platform server 140. Platform server 140 then makes contact with the non-payers database 130 (step E)). In step F) the status data of the person in question is retrieved from the non-payers database 130, after which these are sent in step G) by the non-payers database 130 to platform server 140. The status data are then sent in step H) to input device 120 by platform server 140. Depending on the result, the monitoring party can then proceed with the appropriate action. If a debt is determined, seizure can be made by a bailiff and/or other institution/person authorized to do so. This preferably takes place by placing a wheel clamp. If desired, the vehicle can then be removed and deposited/stored elsewhere and/or be sold.

Referring to FIG. 3, a second embodiment of a system 200 for digitally tracing non-payers comprises a platform server 140, and at least an input/output device 120, such as for instance of the type described above. System 200 further comprises a combined database 160 comprising at least two databases 110 and 130. Database 110 comprises at least the identity data of number plate holders, while database 130 comprises at least the identity data of non-payers. Platform server 140 can be connected via an electronic network to the combined databases 160 and to input/output device 120. If desired, platform server 140 is also connected to server 150 of a payment institution as already described above. In this variant the electronic network can also be a wireless network, a cable network, an analog network, a digital network and/or a combination thereof. A monitoring party has an input/output device 120 at his/her disposal with which vehicle number plates can be registered. If desired, platform server 140 also comprises in this variant a computing unit, an input/output unit which can communicate with the computing unit and allows a user, for instance a monitoring party, to receive output from and/or provide input to the computing unit. A memory communicates with the computing unit and stores the necessary program code and data enabling execution of the desired functions of platform server 140. The memory particularly comprises the necessary software enabling execution of the method according to the present invention. Platform server 140 comprises and/or is in communication with the combined database 160 in which data relating to number plate holders and non-payers are stored, and which data can be accessed by platform server 140 and can be processed if desired. The combined database can be searched in known manner by a suitable software component of the platform server.

Referring to FIG. 4, in a second variant of the method a number plate of a vehicle is scanned in step A) by a monitoring party using a suitable input device 120. Input device 120 comprises for instance a vehicle provided with an ANPR (automatic number plate recognition) system. The combined database 160 is provided with at least number plate data, identity data and status data relating to the debt position of persons. These data, and particularly data relating to the debt position are for instance provided by court bailiffs, debt-collecting agencies, leasing companies, local government authorities and/or private companies. These parties may also provide number plate data and/or social security numbers. By means of input device 120 contact is made via platform server 140 (step B) with the combined database 160. This takes place in step C). The identity data of the person associated with the vehicle with the relevant number plate as well as the status data of the person in question are retrieved from the combined database 160 and in step F) at least the status data are sent to platform server 140 by the combined database 160. The status data are then sent in step G) to input device 120 by platform server 140. The status data are subsequently sent in step H) to input device 120 by platform server 140. Depending on the result, the monitoring party can then proceed with the appropriate action, as already stated above.

It is also noted that it is also possible according to the invention to obtain information concerning the persons with a debt position by using the social security number as input for the above stated databases, instead of or in addition to the number plate. In a preferred method according to the invention, after receipt of the number plate data of persons having a debt position, the debtor is sent, prior to seizure, a letter relating to the registration in which notice is given of the scanning and/or the seizure in respect of non-payment.

The scanning of number plates can be carried out in stationary position at a determined location. It is also possible to scan dynamically, wherein input device 120 for instance travels through a street. The number plates database can be consulted on the spot, preferably on-line, in order to see whether the relevant vehicle is still registered in the name of the debtor or non-payer. This verification can be carried out, if desired, by entering the number plate.

Although the invention has been elucidated and described on the basis of the above stated embodiments, it will be apparent that many modifications and additions can be made thereto which fall within the scope of protection of the following claims.

1-11. (canceled)

12. A method for digital tracing of non-payers and the seizure of property, in particular vehicles, the method comprising at least the following steps, performed under the control of a platform server via a digital network, of:
A) a monitoring party scanning number plates of vehicles with a suitable input device;
B) making contact with a number plates database by means of the input device;
C) retrieving the identity data of the person associated with the vehicle having the relevant number plate from the number plates database;
D) the number plates database sending the identity data to the platform server;
E) making contact with a non-payers database by means of the platform server;
F) retrieving the status data of the relevant person from the non-payers database;
G) the non-payers database sending the status data to the platform server;
H) the platform server sending the status data to the input device,
whereby the status data relate to the debt position of the non-payer, as for instance provided by court bailiffs, debt-collecting agencies, leasing companies, local government authorities and/or private companies.

13. A method for digital tracing of non-payers and the seizure of property, in particular vehicles, the method comprising at least the following steps, performed under the control of a platform server via a digital network, of:
A) a monitoring party scanning number plates of vehicles with a suitable input device;
B) providing a combined database comprising at least number plate data, identity data and status data relating to the debt position of the person associated with number plates;
C) making contact with the combined database via the platform server by means of the input device;
D) retrieving the identity data of the person associated with the vehicle having the relevant number plate from the combined database;
E) retrieving the status data of the relevant person from the combined database;
F) the combined database sending the status data to the platform server;
G) the platform server sending the status data to the input device,
whereby the status data relate to the debt position of the non-payer, as for instance provided by court bailiffs, debt-collecting agencies, leasing companies, local government authorities and/or private companies.

14. The method as claimed in claim 12, wherein it also comprises of immobilizing the vehicle of the person in question if the status data indicate that the person is a non-payer.

15. The method as claimed in claim 14, wherein immobilizing of the vehicle is performed by placing a wheel clamp.

16. The method as claimed in claim 14, wherein immobilizing of the vehicle is performed only when the amount of the debt of the non-payer exceeds a determined limit.

17. The method as claimed in claim 12, wherein the scanning of number plates is carried out in a stationary position at a determined location.

18. The method as claimed in claim 12, wherein the scanning of number plates is carried out dynamically, wherein the input device for instance travels through a street.

19. A computer program comprising program instructions for a computer to execute the method as claimed in claim 12.

20. The computer program as claimed in claim 19, wherein the computer program is arranged on a physical carrier.

21. The computer program as claimed in claim 20, wherein the computer program is at least partially stored in a computer memory.

22. A computer adapted to execute a computer program as claimed in claim 19.

23. The method as claimed in claim 13, wherein it also comprises of immobilizing the vehicle of the person in question if the status data indicate that the person is a non-payer.

24. The method as claimed in claim 13, wherein the scanning of number plates is carried out in a stationary position at a determined location.

25. The method as claimed in claim 13, wherein the scanning of number plates is carried out dynamically, wherein the input device for instance travels through a street.

26. The computer program comprising program instructions for a computer to execute the method as claimed in claim 13.

27. A computer adapted to execute a computer program as claimed in claim 26.
